(19) United States
(12) Patent Application Publication
(10) Pub. No.: US 2023/0374703 A1
(43) Pub. Date: Nov. 23, 2023

(54) Hemp Fiber Extraction and Products Using Green Degumming

(71) Applicant: Trace Femcare, Inc., Franklin, TN (US)

(72) Inventor: Olaf Isele, Franklin, TN (US)

(21) Appl. No.: 18/198,832

(22) Filed: May 17, 2023

Related U.S. Application Data
(60) Provisional application No. 63/343,056, filed on May 17, 2022.

(51) Int. Cl. D01C 1/02

(52) U.S. Cl. CPC D01C 1/02

(57) ABSTRACT

A method for degumming plant fibers without petrochemical-based synthetic chemicals by using a natural oils/waxes and minerals. The method includes cutting fibers into strips of specified lengths and washing the strips in baths of a non-petrochemical synthetic oil/wax and lye, citric acid mixed with water, and lye mixed with water. After each of the baths, the strips are rinsed with water, either deionized or distilled. Some of the washing steps may be performed at cooking temperatures. The method includes drying, opening, and cleaning the fibers.

### FIELD OF THE DISCLOSURE

The present disclosure generally relates to generating cellulosic fibers from vegetable plants.

### BACKGROUND OF THE DISCLOSURE

Extraction of individual cellulosic fibers from vegetable stalks is typically performed by mechanical or chemical means. The fibers are extracted from bast, skin, and/or phloem cells found in the stalks. The fibers are held together by pectin, lignin, and other carbohydrate molecules. Decomposition of the molecules holding the fibers together eases the process of mechanical extraction and individualization of the fibers.

Decomposition is often carried out in two or more steps, such as: 1) retting, where binding compounds in phloem cells are decomposed, 2) decortication, where hurd is separated from bast, and 3) degumming, where non-cellulose materials that render fibers viscous or sticky are removed.

One example of current processes is disclosed in Chinese patent CN106567138B, which describes the details of a state-of-the-art chemical degumming method. A fine processing method for hemp is comprised of the following steps: The first step, the steaming and decortication removal step of hemp phloem. Hemp stalk with hurd and phloem is placed in rotary spherical digester, or cooker, injection cooking liquor until the phloem is completely covered. Then the liquor with the hemp phloem is heated to boiling for 0.5-1 hour; the hemp stalk pieces are stirred. Then you can carry out hemp phloem remove impurity process. Then, the hemp phloem processed through remove impurity is taken out, it is standby. The cooking liquor is the mixed aqueous solution of surfactant and metal ion chelation agent, wherein, the concentration of surfactant Percent concentration is 0.1 percent-2 percent, and the mass percent concentration of metal ion chelation agent is 0.3 percent˜0.5 percent. The surfactant is a combination of sulfated castor oil, dodecyl sodium sulfate, sodium lauryl sulphate, DBSA Sodium, dioctyl sodium sulfosuccinate, Laurel alcohol sulfuric ester MA24F, SAS SAS60, pull open powder, fast penetrant T, one or more in penetrating agents JFC, paregal O, alkylphenol polyoxyethylene TX-10, N-ethyl pyrrolidone NEP-100. The metal ion chelation agent is sodium tripolyphosphate, sodium hexameta phosphate, sodium pyrophosphate, sodium silicate, sodium citrate, benzoic acid. One or more of sodium, polyacrylamide, sodium salicylate, tetrasodium ethylenediamine tetraacetate. Second step, steam explosion activation process step. The hemp phloem after removal of impurities like hurd is placed in steam explosion device, is passed through steam, until in steam explosion device. The pressure of vapor reaches 1.0˜1.5 MPa, and pressurized 1˜5 minute at this pressure. Then, rapid pressure release leads to quick evaporation, then wash with clear water washes clean after. This obtains the dispersing the hemp phloem of activation. 3rd step, beating the loosened hemp phloem (cake dress cage step). The hemp phloem from the steam explosion dispersion activation, is similar to a cake is beaten using pancake making machine. During feeding, a stirrer is running with 3˜5 Rev/min speed, do not stop rotation. This pancake making machine machinery mixing stirrer moves around and up and down and beats the hemp phloem. Meanwhile, watering is fed into the vessel from upper to lower drip washing of continuously spraying water into container. The drip washing water temperature is 50 DEG C. to 80 DEG C. 4th step, directional catalyzing oxidation step. After the beating and rinsing steps, the hemp phloem from the mixing container is transferred in glue kettle, liquid feed valve is opened, using high pressure. A pump first injects ferrous salt solution into the kettle until the hemp phloem is below the liquid level. Then, continue to keep high-pressure pump operating, so that ferrous salt solution and outside ferrous salt solution forced circulation in glue kettle. Hold ferrous salt solution in glue kettle and, all the time with swiftly and constantly stirring to cause impingement hemp phloem, after 15˜30 minutes, stop high pressure pump, by closing liquid feed valve. Then, liquid feed valve is opened, first activator body lotion is injected into glue kettle using high-pressure pump and was not had hemp phloem to liquid level. Afterwards, continue to keep high-pressure pump operating, so that activator body lotion and external activator body lotion forced circulation in glue kettle, keep degumming Activator body lotion is all the time with swiftly flowing state constant impingement hemp phloem in tank, after 1˜2 hour, stop high-pressure pump, close into Liquid valve, opening liquid valve, will close liquid valve after the activator body lotion emptying in glue kettle. The activator is hydrogen peroxide H₂O₂, peracetic acid or carbamide peroxide solution. 5th step, the final chemical degumming step. Alkaline degumming liquid is pumped into the kettle, did not had hemp phloem, heated and boiled, and the continuous steaming under fluidized state with the liquid at boiling temperature for 0.5˜2 hours. Then, liquid valve is opened, and the degumming liquid is emptied; liquid valve is closed. Then, liquid feed valve is opened, sulphuric acid body lotion or hydrochloric acid body lotion is injected into kettle, and the hemp phloem is washed to pH value of 7 or less. Finally, clear water is used to rinse the degummed phloem repeatedly is reused. As a result, hemp semi-finished product is obtained. 6th step, post-processing step. Resulting hemp semi-finished product successively dried, dehydrated, and oiled to coat the fibers with a soft finish, dried again, and the hemp finished product is obtained.

A shortcoming of the current chemical processes is the residual amounts of petrochemical-based synthetic chemicals and harsh chemicals that are present in the degummed fibers.

What is needed is a method of degumming cellulosic fibers without using petrochemical-based synthetic chemicals or harsh chemicals.

### SUMMARY OF THE DISCLOSURE

The present disclosure is of a method for producing cellulosic fibers from plants particularly hemp plants, without the use of petrochemical-based synthetic chemicals or harsh chemicals.

One embodiment of the present disclosure is a method of degumming plant fibers, the method including the steps of: decorticating bast into raw fibers; selecting or cutting the raw fibers into strips of selected length; dedusting the strips; washing the strips into washed strips; cooking the washed strips into cooked strips; refining the cooked strips into refined strips; processing the refined strips with enzymes into processed strips; bleaching the enzymatically processed strips into bleached strips; cooking the bleached strips in to cooked bleached strips; softening the cooked bleached strips into softened strips; drying the softened strips into dried strips; opening the dried strips to extract fibers; and cleaning the opened fibers into finished fibers. The method may also include the step of decorticating bast stalk into the bast. The raw fibers have a hurd amount of less than 1 percent after decorticating of the bast. The washed strips may be (optionally) steamed before cooking. The step of washing the strips, in some aspects, may include the steps of: washing the strips with oil/wax in concentration of about 0.2 percent to about 5 percent and lye in a concentration of about 0.2 percent to about 5 percent mixed with water; washing the strips with citric acid mixed with water in a concentration of about 0.05 percent to about 0.5 percent; and rinsing the strips with water after each washing. In some aspects, washing the strips may further include washing with acetic acid mixed with water in a concentration of about 0.05 percent to about 0.5 percent; washing the strips with sodium bicarbonate mixed with water in a concentration of about 0.05 percent to about 0.5 percent; washing the strips with lye mixed with water in a concentration of about 0.2 percent to about 5 percent; and rinsing the strips with water after each washing. The method may also include bleaching the cooked bleached strips before the softening step.

Another embodiment of the present disclosure may include a method of degumming plant fibers, the method including the steps of: decorticating bast into raw fibers; selecting or cutting the raw fibers into strips of selected length; dedusting the strips; washing the strips into washed strips; cooking the washed strips with lye and water into first stage cooked strips; cooking the cooked strips with citric acid and water into second stage cooked strips; drying the second stage cooked strips into dried strips; opening the dried strips to untangle fibers; and cleaning the opened fibers into finished fibers. The method may also include the step of decorticating bast stalk into the bast. The raw fibers have a hurd amount of less than 1 percent after decorticating the bast. In some aspects, the step of washing the strips into washed strips may include: washing the strips with oil/wax in concentration of about 0.2 percent to about 5 percent and lye in a concentration of about 0.2 percent to about 5 percent mixed with water; washing the strips with citric acid mixed with water in a concentration of about 0.05 percent to about 0.5 percent; and rinsing the strips with water after each washing. In some aspects, the washing step may further include: washing the strips with acetic acid mixed with water in a concentration of about 0.05 percent to about 0.5 percent; washing the strips with sodium bicarbonate mixed with water in a concentration of about 0.05 percent to about 0.5 percent; washing the strips with lye mixed with water in a concentration of about 0.2 percent to about 5 percent; and rinsing the strips with water after each washing.

Another embodiment of the present disclosure may include a method of preparing and washing plant fibers, the method including the steps of: selecting raw fibers for degumming; cutting the raw fibers into strips of selected length; dedusting the raw fibers; washing the strips with oil/wax in concentration of about 0.2 percent to about 5 percent and lye in a concentration of about 0.2 percent to about 5 percent mixed with water; washing the strips with citric acid mixed with water in a concentration of about 0.05 percent to about 0.5 percent; and rinsing the strips with water after each washing. In some aspects, the method may also include the steps of: washing the strips with acetic acid mixed with water in a concentration of about 0.05 percent to about 0.5 percent; washing the strips with sodium bicarbonate mixed with water in a concentration of about 0.05 percent to about 0.5 percent; washing the strips with lye mixed with water in a concentration of about 0.2 percent to about 5 percent; and rinsing the strips with water after each washing.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

The organization and manner of the structure and operation of the invention in this disclosure, together with further objects and advantages thereof, may best be understood by reference to the following description taken in connection with the accompanying drawings wherein like reference numerals identify like elements in which:

FIG. 1 is a flow chart of a method of degumming plant fibers according to one embodiment of the present disclosure.

FIG. 2 is a flow chart of a method of degumming plant fibers according to one embodiment of the present disclosure.

FIG. 3 is a flow chart of the preparation and washing steps shown in FIGS. 1 and 2 according to one embodiment of the present disclosure.

### DETAILED DESCRIPTION OF THE DISCLOSURE

While this invention may be susceptible to embodiments in different forms, specific embodiments are shown in the drawings and will be described herein in detail with the understanding that the present disclosure is to be considered an exemplification of the principles of the invention and is not intended to limit the invention to that as illustrated.

The problems presented by current fiber extraction and chemical processing methods may be avoided using a degumming process that uses natural oil/wax components and minerals and does not use petrochemical-based synthetic chemicals and other harsh chemicals. Herein natural oil/wax means derived directly from plant or animal tissue rather than man-made through chemical alteration or synthesis.

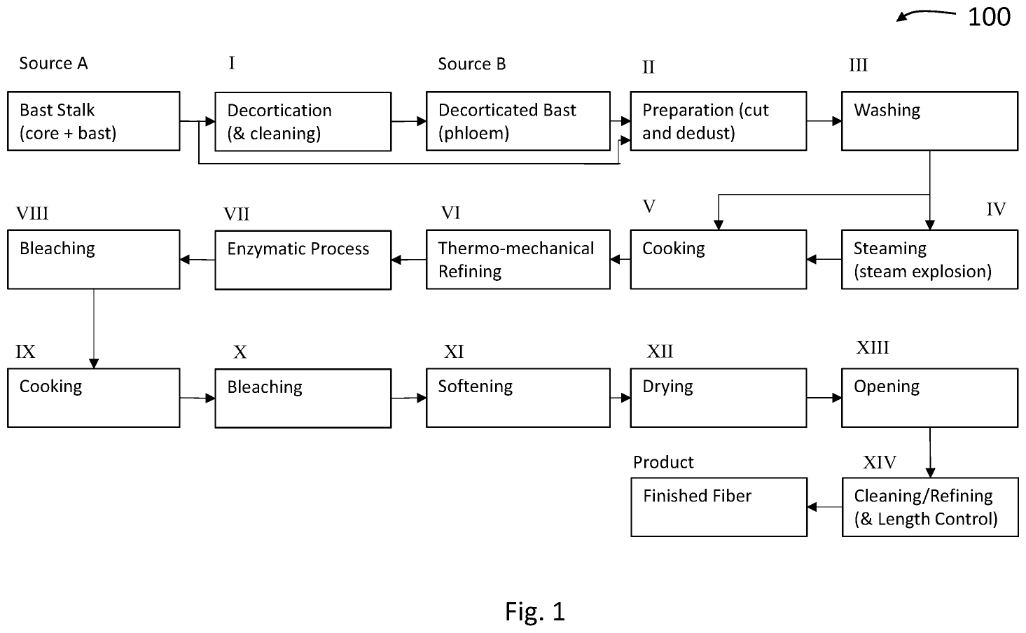

FIG. 1 shows a method 100 for degumming plant fibers according to the present disclosure. The plant fibers may be sourced as bast stalk Source A or decorticated base Source B. In step I, the bast and the hurd (or core or shives or woody parts) are separated from each other. For our purpose, we continue processing the bast fiber. Actually, the bast fiber at this point are not individual cellulosic fibers, rather it is often referred to as “raw fiber.” Raw fiber is a combination of the bundles of elemental fibers as well as strips of bast (phloem) that each include multiple bundles of elemental fibers. Generally, such decortication lines are well known in the industry. For example, they can be bought from Laroche in France, Temafa in Germany, or Canadian Greenfield Industries in Canada. The decorticated bast after this step should be containing less than 5 percent “wood” (shives, hurd), preferably less than 3 percent or most preferred less than 1 percent or 0.5 percent. The amount of hurd is determined with a gravimetric method by selecting representative samples (and weighing them) from the whole amount of bast or raw fiber, separating the hurd from the fiber and measuring the weight of the separated hurd divided by the total weight of the samples before removing the hurd. The bast fiber dimensions now may be between a few to several thousand millimeters, e.g. 1 to 3000 mm, typically between 1 to 100 centimeters and preferably between 2 cm to 50 cm. Step I may not be performed if using decorticated bast.

In step II, the bast fiber, either from step I or decorticated bast, is prepared into strips for washing. The preparation step separates the large bast raw fiber into finer raw fiber pieces with relatively small cross-sectional dimension (width or height or diameter or cross-sectional axes) of less than 1 millimeter and preferably to less than 500 or even 200 micrometers, but possibly at the lower end of the size distribution down to the cross-section of individual elemental fibers, i.e. 10 to 30 micrometers or larger. Another goal of this step is the reduce the length distribution of the raw bast fiber to somewhere between 15 to 100 mm or even between 20 and 50 mm. The raw bast fiber may be selected or cut to a suitable length. The preparation step also includes dedusting to remove dirt and debris, such as soil or rock pieces, as well as dust (pieces smaller than 1 mm) from the raw fiber. The reason for that is to achieve better machine performance (and life expectancy) as well as processing efficiency in the later processing steps. Dedusting reduces the risk of damage to equipment from little rock pieces and makes the processing more efficient because dust would only use up some of the chemical components of the processing which would be a waste.

Prepared bast fiber from step II should meet the following quality requirements. Those quality requirements include at a minimum the length distribution of fibers (raw fiber, bast strips), the cross-sectional size (width or diameter), the amount of hurd (shives, wood), and the amount of dust, dirt and other contamination. The length of the raw fiber before beginning the wet processing should be between 1 to 100 cm, and preferably between 2 to 50 cm. An ideal distribution of the raw fiber here would be between 20 to 60 mm (millimeters) and have an average and median length between 30-40 mm or around 35 mm (within 10 percent). The cross-sectional axis should be roughly between 20 to 500 micrometer or, if possible, already between 20 to 200 micrometers. At this point, the 90 percentile value of the statistical distribution of the cross-sectional width may still or will be over 100 micrometers, and typically is 150-300 micrometer, but should be less than 500 micrometers. All those properties can be measured manually with rulers or with microscopes and image analysis, and with representative sampling and sufficient number of data points (minimally 50 data points). Other ways to measure would be with FibreShape by IST-AG or with Fibromat by Textechno or with OFDA-4000. The amount of remaining hurd (shives, wood) can be determined gravimetrically and at this point should be less than 1 percent or preferably less than 0.5 percent.

The amount of dust, dirt and other contamination, which can be measured gravimetrically using sieves or can be measured using the instrument MDTA-4 from Textechno, should be less than 1 percent, preferably less than 0.1 percent, or much less than 1 item per 1 gram of fiber sample. When referring to the fineness or size—but there not the length dimension—of the fibers or fiber bundles or bast strips, the words that are often used are diameter or width. In this disclosure, the fineness is usually referred to as the cross-sectional size or axis. Elongated objects with a measurable cross-sectional area, such an axis can be a diameter as for objects with a circular cross-section, or major and minor axes for elliptical cross-sections, or width and height or thickness for oval or largely rectangular cross-sections. When speaking of a cross-sectional dimension, the word axis is typically used, but the other words like diameter, width or thickness are may be used interchangeably. Often, when describing the fineness of fibers, a linear density expression is used, which is the mass of a fiber divided by a specified length of a fiber. For denier, the mass of a fiber for a theoretical 9000 m length is calculated and reported in denier. For Tex, it is the mass divided by a 1000 m length, and for dtex (decitex) it is the mass divided by 10000 (ten thousand) meters. To convert between a cross-sectional axis and such linear density, one can make a simplified assumption of a circular cross-section without a hollow core of the fiber (or fiber bundle) and using a density of matter of 1500 kg/m3 (kilogram per cubic-meter) that represents cellulose. It is possible to make additional assumptions for hollowness or ovalness (elliptic form factor), but that initial simple conversion is practically sufficient for quality control.

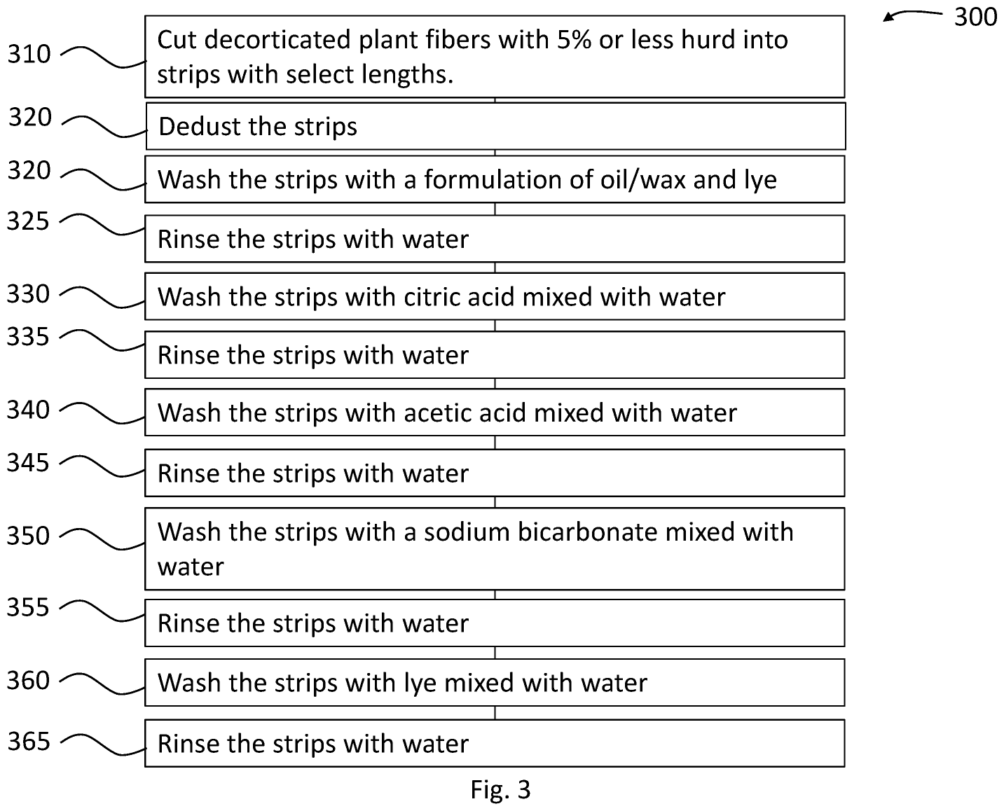

In step III, the strips are washed to remove oils and waxes that may still be on the raw fiber at this point. It also removes remaining dirt that may still be present. Washing can be done with water only or by mixing the formulation of non-petrochemical synthetic oil/wax and lye with water and heating it to relatively high temperature between 20 degrees Celsius to 100 degrees Celsius, and then stirring the raw fiber in this liquid, often called “liquor,” for a specified duration between 0.5 to 2 hours. When the formulation is used, the amount in water is selected between 1 gram per liter to 50 gram per liter (1-50 g/L). Mixing may be performed by stirring with a speed of 1 to 5 revolutions per minute (1-50 RPM). More specifically, the energy intensity utilized can also be measured in energy per mass of fiber-liquid mix, which ranges between 0.1 to 200 kWh/ton, or more narrowly between 1 to 150 kWh/ton. After this washing, the formulation is drained. The drained fiber may be washed and rinsed with water (deionized or distilled) at ambient conditions at a mass to liquid ratio of 1:10. This rinsing is optional. Wet processing steps are performed in heated, i.e. heatable, kettles (or kiers or tanks) that can be sealed off to reduce heat loss as well as to achieve pressurized processing above ambient, with integrated stirrers or impellers to keep mixing the formulation of water, active components and fiber. Typically, the ratio of the amount of fiber to be processed in the amount of liquid (completed formulation of water with active components) is between 1 to 5 and 1 to 50, or preferably between 1 to 5 and 1 to 20. For example, processing 1 kg of raw fiber in 10 kg of a mix of water and soap. Practically, the material to liquid ratio is very similar to kg fiber to liter of liquid, since water makes up the vast proportion of the liquids used in these processes, e.g. 1 kg of fiber in 10 liters of water mixed with soap. In some embodiments, washing may be performed using steps 320-365 of method 300 (see FIG. 3).

In step IV, optionally, steaming or steam explosion may be used. The steaming may be done just with water or with a soap-water mix like in the washing step. The tank is filled with fiber and liquid and then heated such that the internal conditions reach between 100 to 150 degrees Celsius and 2 to 15 bar pressure (0.2-1.5 MPa) for a period of 10 to 60 minutes. If steam explosion is used, the conditions need to reach between 10 to 15 bar of pressure above 100 degrees Celsius for a duration of 1 to 5 minutes and then the pressure needs to be released suddenly, within 0.1 to 1.0 seconds so that the rapid evaporation of water within the fiber bundles and the raw fiber strips leads to significant extraction of the elemental fibers already.

In step V, the moist fibers are mixed with lye or caustic soda. If the liquid lye is used with a pH of 13, then the concentration of the lye in water may be between 5 to 1000 g/L, i.e. diluted or pure. (The moisture of the fibers is drip dry or between 50 to 150 percent by weight.) This cooking occurs at boiling temperature around 100 degrees Celsius for a duration between 1 to 10 hours. With a pressure-proof kettle, the temperature may be elevated to 110-130 degrees Celsius and the duration may be reduced to 1-2 hours. After the liquid is drained, the fiber mass may be rinsed with water.

In step VI, optional thermo-mechanical refining may be used to break free the elemental fibers. In that case a slurry of with 1-10 percent or preferably around 4 percent fiber in water at a temperature between 80 to 100 degrees Celsius is pumped into a refiner, preferably a conical refiner (e.g. similar to Valmet RGP 76 CD). Either soap or caustic soda similar to the washing or cooking steps before may be added into that slurry. The fibers in the slurry are sheared and due to the stresses, the fiber strips and fiber bundles break apart into the individual elemental fibers. The slurry is fed through a gap in the refiner between the rotating or shearing surfaces with a gap (spacing) between 50 to 1000 micrometers, or preferably between 100 to 500 micrometers. The residence time of the fibers in the slurry in the process is only between 0.1 to 100 seconds depending on the gap and temperature. The refining energy used in this process step is between 1 to 200 kWh/ton, or preferably between 1 and 50 kWh/ton. Afterwards the slurry is drained of liquid and the remaining mass of fibers may be rinsed once or twice.

In step VII, an enzyme treatment (xylanase, pectinase or a cellulase-type enzyme, or a combination thereof) is mixed with water at a concentration between about 0.05 and about 5 percent is added to the fiber at a fiber to enzyme solution weight ratio between about 1:1 and about 1:100 and is stirred at a temperature within a range of about 20 to about 65 degrees Celsius for a duration of about 10 to about 60 minutes. In some embodiments, the enzyme concentration is between about 1 percent and about 2.5 percent. After the enzyme solution is drained, the remaining fiber is rinsed once or twice, to remove the non-fiber organic content well.

In step VIII, an optional bleaching step may be performed. This step can be effectively added after the initial cooking and degumming steps. Hydrogen peroxide at a concentration of 2-10 g/L (or preferably 4-6 g/L) is mixed with water and heated to 80 to 100 degrees Celsius. The fiber is added and mixed at this temperature for 40 to 80 minutes. Afterwards the liquid is drained. If rinsing is done, it may be done with water only, or with a slightly acidic solution using acetic acid or sulfuric acid. Using plant-based acetic acid is preferable. The rinsing solution has a pH between 7 and 9. Again the solution is emptied, and the fiber is drained from free liquid.

In step IX, a second cooking may be performed using citric acid in combination with water. The forms of citric acid or citrate may be pure citric acid or sodium-citrate in the form of Di-sodium-citrate or preferably even tri-sodium citrate. The citrate is mixed with water at a concentration of 0.2 to 10 percent (2 to 100 g/Liter), preferably at a concentration between 0.5 to 5 percent (5-50 g/Liter). The mix is stirred at a temperature of 60 to 100 degrees Celsius for 1-10 hours, preferably at 80-95 degrees Celsius for 2-6 hours. Then, the liquid is drained, and it may be rinsed once.

In step X, a bleaching may be performed where the drained but still wet (just dripping wet) fiber is filled into a vessel then ozone is flooded into the vessel up to a concentration of 10 to 1000 ppm. The mix is agitated (e.g. a rotating drum or an impeller) with 1-5 RPM for a duration of 10 to 60 minutes. The available oxygen radicals will lead to the degradation and clearing of the still remaining natural colorants. The bleaching can be controlled by the combination of ozone concentration and exposure time. Before the vessel is opened, the ozone is pumped out of the vessel and actively destroyed, i.e. turned back into oxygen gas to prevent any further reaction or harm. In the most preferred recipe for the process, there is no bleaching done. In some embodiments, this second bleaching may be optional.

In step XI, the remaining fiber after draining can now be softened by mixing it with oil at a concentration of 1-2 percent by weight. The oils used is any or is any combination of natural oils including, but not limited to, coconut, canola oil, flax oil, hempseed oil, and olive oil, as would be understood by persons of ordinary skill in the art.

In step XII, the fiber may be dried to a remaining moisture of between 5 to 20 percent, or preferably between 7 and 15 percent. The drying happens preferably with air heated to 40-80 degrees Celsius while the fiber is being agitated to enable even and efficient drying. If the fiber is turned into bales before or after the opening and refining, then the moisture level should be better controlled between 7 and 9 percent.

In step XIII, the fibers may be opened since after degumming and drying, the fibers may be in a very entangled state, being roped around each other and not easy to individualize and process for the final application of the resulting fiber, e.g. spinning into yarn for textiles, or carding into slivers or wadding tapes for tampon production, or blending with other fibers for nonwoven production which in turn may be used for producing absorbent hygiene products. Therefore, the fibers need to be opened using equipment such as wool or cotton combing machines equipped with pin rollers. Alternatively, a cotton card can be used. The use of a nonwoven card requires significant changes in the set-up to avoid the tearing as well as nep formation during the carding process, but it is possible and known how to for one familiar with the art.

In step XIV, the fibers must be cleaned and refined. This means that additional dust and fiber fractures that have been created during the preceding processes need to be removed. This is achieved with step cleaners such as Temafa LIC in combination with Temafa model LOV, followed by fine-openers such as a Rieter Uniflex B60. An important function of this step is to produce bast fibers with a narrow length distribution. The refined fibers are now mostly elemental fibers with less than 0.1 percent dust or trash in them. The chemical composition analysis via spectroscopy or chromatography shows that the cellulosic content of these fibers is above 80 percent. The length distribution of the fibers is between 15 to 50 mm, and with over 50 percent to 80 percent of the fibers between 20 and 45 mm and a 90 percentile in a statistical distribution over 40 mm or preferably between 40 to 45 mm. The cross-sectional size of the resulting fibers has an average between 25 to 50 micrometers or preferably between 25 to 35 micrometers while the median size is between 15 to 40 micrometers, or preferably between 15 to 30 micrometer or even between 15 to 25 micrometers. The 90 percentile in a statistical distribution of the “width” of the resulting fibers is less than 50 micrometers or preferably less than 40 or even 35 micrometers. The 95 percentile in a statistical distribution of the “width” of the resulting fibers is less than 100 micrometers, preferably less than 80 micrometers, or even more preferably less than 50 micrometers.

In one illustrative, non-limiting example, the decorticated and mechanically cut and cleaned raw bast fiber contains less than 1 percent hurd and less than 1 percent dust or dirt. The vast majority, or about 80 percent, of the length of the fibers range from 20 to 60 mm and the cross-sectional size ranges between 10 and 300 micrometers, that is over 90 percent. These fibers go into the following wet degumming steps: washing in a formulation of non-petrochemical oil/wax and lye, then cooking in lye, followed by cooking in citric acid. For the washing, 20 g/L of the formulated soap is dissolved in water at 80 degrees Celsius. Then the raw fiber is added at a ratio of fiber:liquid of 1:10 and is stirred at 20 RPM at that temperature for 100 minutes. Then the liquid is drained. The next step for cooking is prepared in another kettle by heating lye (water and caustic soda) at a pH of 13 to a temperature of 80 degrees Celsius. Fiber is added at a ratio of 1 kg fiber to 15 liters of liquor. This mix is stirred at 20 RPM at that temperature for a duration of 60 minutes. The liquid is then drained, and the fiber transferred to the third kettle. In the third kettle is tri-sodium citrate in a concentration of 1 percent and at a temperature of 85 degrees Celsius. The mix is stirred at that temperature for a duration of 3 hours. The resulting fibers are analyzed before running them through opening, cleaning and refining. This analysis is possible because while the fibers are still roped around each other, it is obvious that the fibers are not in the form of bundles (cellulose fibers in a matrix of lignin and pectin), but now degummed and extracted. The length distribution (over 99 percent) of the fibers range from 15 to 55 mm. The cross-sectional “width” of the fibers has an average of 31.7 micrometers and a median of 21.2 micrometer. The 90 percentile of the width distribution is 43.2 micrometer.

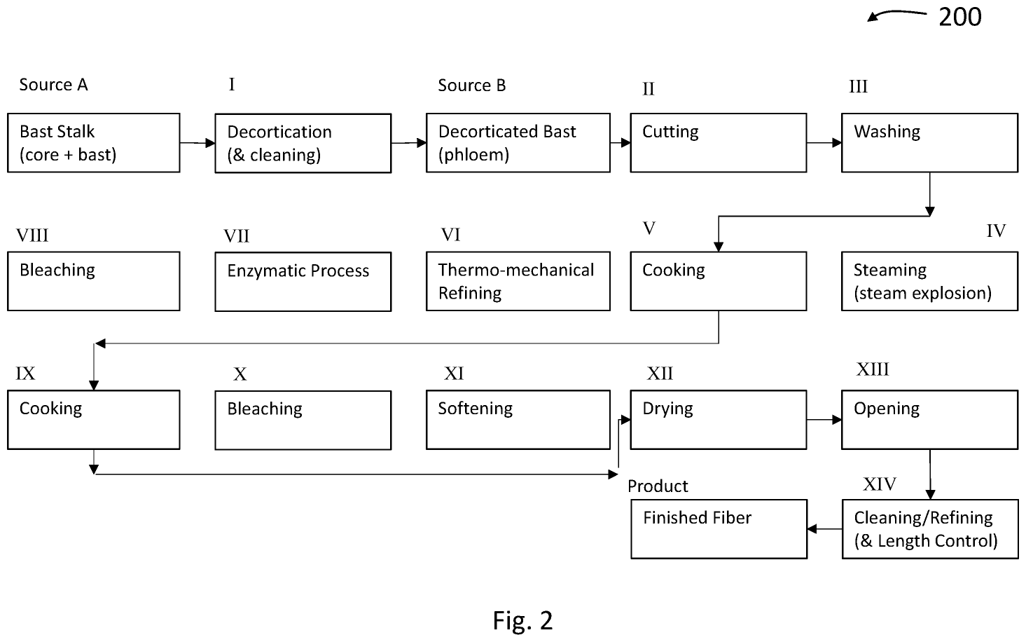

FIG. 2 shows a flow chart of a method 200, which is an alternative degumming process according to one embodiment of the present disclosure. In method 200, certain optional steps from method 100 are not used. Thus, step III leads to step V, step V leads to step IX, and step IX leads to step XII The teachings of all steps performed in method 200 are consistent with the method 100.

FIG. 3 shows a flow chart diagram of a method 300 for preparing and washing decorticated plant fibers, such as, but not limited to, hemp fibers. In some embodiments, the method 300 may be used in place of steps II and III of method 100 and method 200. In step 310, a decorticated raw fiber is cut into strips. The decorticated raw fiber may have less than 5 percent hurd. In some embodiments, the decorticated raw fiber may have less than 1 percent hurd. The strips may be at least 20 mm in length. In some embodiments the strips may be between about 15 mm and about 100 mm in length. In some embodiments, the strips may be between about 25 mm and about 50 mm in length. In some embodiments, the strips may be between about 30 and about 40 mm in length. In step 315, the cut strips may be dedusted to remove debris, such as small rocks that can damage machinery, and fiber dust that can increase the amount of chemicals required in downstream processing steps. In step 320, the strips may be washed in a bath. Washing the fibers in a bath is illustrative and exemplary only, as other washing techniques may be used for this and other washing steps as would be understood by a person of ordinary skill in the art. The washing may include a wetting agent applied in a concentration of about 0.05% to about 0.5%. Suitable wetting agents can include alcohols, such as, but not limited to, alcohol-based low-foaming wetting agents such as alkoxylated alcohols, glycol, dioctyl sulfosuccinate, polyethyleneglycol or polypropyleneglycol, and saponins, such as those extracted from the yucca plant. The bath may include formulation of a soap made of a non-petrochemical synthetic oil/wax and lye. The oil or wax may include any suitable non-petrochemical synthetic oil/wax, including, but not limited to, one or more of: paraffin, animal tallow, beeswax, canola oil, coconut oil, olive oil, a fruit kernel oil, and a fruit seed oil. The oil/wax may have a concentration of about 0.2 percent to about 5 percent mixed in water. Lye may include at least one of sodium hydroxide and potassium hydroxide. The lye may have a concentration of about 0.2 percent to about 5 percent mixed in water. In some embodiments, the oil/wax may be about 1 percent to 2 percent and the lye may be about 1 percent to 2 percent when the steps 360 and 365 are performed, and the oil/wax may be about 2 percent to 4 percent and the lye may be about 2 percent to 4 percent when the steps 360 and 365 are not performed. In step 325, the strips may be rinsed with at least one of: deionized water and distilled water. In step 330, the strips may be washed in a bath of citric acid and water. The citric acid may have a concentration of about 0.05 percent to about 0.5 percent. In some embodiments, the citric acid may be about 0.2 percent when the steps 340-355 are performed, and the citric acid may be about 0.4 percent when the steps 340-355 are not performed. In some embodiments, this step (and rinsing step 335) is optional or may replace the citric acid wash in step IX of method 100 and method 200. In step 335, the strips may be rinsed with at least one of: deionized water and distilled water. In step 340, the strips may be washed in a bath of acetic acid mixed with water. The acetic acid may have a concentration of about 0.05 percent to about 0.5 percent. In step 345, the strips may be rinsed with at least one of: deionized water and distilled water. In some embodiments, steps 340 and 345 are optional. In step 350, the strips may be washed in a bath of baking soda (sodium bicarbonate) mixed with water. The sodium bicarbonate may have a concentration of about 0.05 percent to about 0.5 percent. In step 355, the strips may be rinsed with at least one of: deionized water and distilled water. In some embodiments, steps 350 and 355 are optional. In step 360, the strips may be washed in a bath of lye and water (concentration of about 0.2 percent to about 5 percent). In step 365, the strips may be rinsed with at least one of: deionized water and distilled water. In some embodiments, steps 360 and 365 may be optional or may replace the lye wash step V of method 100 and method 200. The wash and rinse steps are paired and can be performed in any order. Thus, steps 350 and 355 may precede steps 330 and 335 in some embodiments, for example. In some embodiments, one or more of the wash and rinse pairs may be repeated.

Once degummed, the fibers may be mechanically separated without the presence of petrochemicals or harsh chemical residue. The fibers may be used for manufacturing of hygienic products, including, but not limited to, wipes, diapers, tampons, and feminine napkins, as would be understood by a person of ordinary skill in the art.

While embodiments in the present disclosure have been described in some detail, according to the preferred embodiments illustrated above, it is not meant to be limiting to modifications such as would be obvious to those skilled in the art.

The foregoing disclosure and description of the disclosure are illustrative and explanatory thereof, and various changes in the details of the illustrated apparatus and system, and the construction and the method of operation may be made without departing from the spirit of the disclosure.

What is claimed is:

1. A method of degumming plant fibers, the method comprising the steps of:
decorticating bast into raw fibers;
selecting or cutting the raw fibers into strips of selected length;
dedusting the strips;
washing the strips into washed strips;
cooking the washed strips into cooked strips;
refining the cooked strips into refined strips;
processing the refined strips with enzymes into processed strips;
bleaching the enzymatically processed strips into bleached strips;
cooking the bleached strips in to cooked bleached strips;
softening the cooked bleached strips into softened strips;
drying the softened strips into dried strips;
opening the dried strips to extract fibers; and
cleaning the opened fibers into finished fibers.

2. The method of claim 1, further comprising the step of:
decorticating bast stalk into the bast;

3. The method of claim 1, wherein the raw fibers have a hurd amount of less than 1 percent.

4. The method of claim 1, wherein the washed strips are steamed before cooking.

5. The method of claim 1, wherein the step of washing the strips into washed strips comprises:
washing the strips with oil/wax in concentration of about 0.2 percent to about 5 percent and lye in a concentration of about 0.2 percent to about 5 percent mixed with water;
washing the strips with citric acid mixed with water in a concentration of about 0.05 percent to about 0.5 percent; and
rinsing the strips with water after each washing.

6. The method of claim 5, further comprising:
washing the strips with acetic acid mixed with water in a concentration of about 0.05 percent to about 0.5 percent;
washing the strips with sodium bicarbonate mixed with water in a concentration of about 0.05 percent to about 0.5 percent;
washing the strips with lye mixed with water in a concentration of about 0.2 percent to about 5 percent; and
rinsing the strips with water after each washing.

7. The method of claim 1, further comprising:
bleaching the cooked bleached strips before the softening step.

8. A method of degumming plant fibers, the method comprising the steps of:
decorticating bast into raw fibers;
selecting or cutting the raw fibers into strips of selected length;
dedusting the strips;
washing the strips into washed strips;
cooking the washed strips with lye and water into first stage cooked strips;
cooking the cooked strips with citric acid and water into second stage cooked strips;
drying the second stage cooked strips into dried strips;
opening the dried strips to untangle fibers; and
cleaning the opened fibers into finished fibers.

9. The method of claim 8, further comprising the step of:
decorticating bast stalk into the bast;

10. The method of claim 8, wherein the raw fibers have a hurd amount of less than 1 percent.

11. The method of claim 8, wherein the step of washing the strips into washed strips comprises:
washing the strips with oil/wax in concentration of about 0.2 percent to about 5 percent and lye in a concentration of about 0.2 percent to about 5 percent mixed with water;
washing the strips with citric acid mixed with water in a concentration of about 0.05 percent to about 0.5 percent; and
rinsing the strips with water after each washing.

12. The method of claim 11, further comprising:
washing the strips with acetic acid mixed with water in a concentration of about 0.05 percent to about 0.5 percent;
washing the strips with sodium bicarbonate mixed with water in a concentration of about 0.05 percent to about 0.5 percent;
washing the strips with lye mixed with water in a concentration of about 0.2 percent to about 5 percent; and
rinsing the strips with water after each washing.

13. A method of preparing and washing plant fibers, the method comprising the steps of:
selecting raw fibers for degumming;
selecting or cutting the raw fibers into strips of selected length;
dedusting the raw fibers;
washing the strips with oil/wax in concentration of about 0.2 percent to about 5 percent and lye in a concentration of about 0.2 percent to about 5 percent mixed with water;
washing the strips with citric acid mixed with water in a concentration of about 0.05 percent to about 0.5 percent; and
rinsing the strips with water after each washing.

14. The method of claim 13, further comprising:
washing the strips with acetic acid mixed with water in a concentration of about 0.05 percent to about 0.5 percent;
washing the strips with sodium bicarbonate mixed with water in a concentration of about 0.05 percent to about 0.5 percent;
washing the strips with lye mixed with water in a concentration of about 0.2 percent to about 5 percent; and
rinsing the strips with water after each washing.
